(19) United States
(12) Patent Application Publication
(10) Pub. No.: US 2019/0101153 A1
(43) Pub. Date: Apr. 4, 2019

(54) FILTER CONNECTION TIP OF A SHEATH OR CABLE IN A HOLDER

(71) Applicant: DURA AUTOMOTIVE SYSTEMS SAS, Bievres (FR)

(72) Inventor: Jean-Marie Biaggini, Neauphle Le Vieux (FR)

(21) Appl. No.: 15/743,124

(22) PCT Filed: Jul. 7, 2016
(86) PCT No.: PCT/FR2016/051736

§ 371 Date: Jan. 9, 2018

(30) Foreign Application Priority Data
Jul. 15, 2015 (FR) FR1556676

(51) Int. Cl. F16C 1/26; F16C 1/10

(52) U.S. Cl. CPC F16C 1/262; F16C 1/12; F16C 2361/65; F16C 1/103

(57) ABSTRACT

A tip has a first element made of a rigid material and attached to the end of the sheath or cable, and to a second element made of a flexible material and molded over the first element, each of said elements and defining a portion and intended to be inserted into an arrangement of the holder having limited coaxial movement capability corresponding, under an axial force exerted on the sheath or cable, to crushing said portion of the flexible element up to a symmetrical contact area abutment position on the surface of said portion, said contact areas abutting against a portion of the arrangement of the holder to limit the travel under the force of the crushing of the flexible material of the second element.

### TECHNICAL FIELD

The disclosure relates to the technical field of components for motor vehicles.

### BACKGROUND

More particularly, the disclosure relates to the attachment of sheathes, cables or the like to a holder mounted, for example, on a mechanical or automatic gearbox. Cables or the like may be used, for example, for selecting and/or changing gears, by means of a control member. Usually, the cable or the like has, at least at one of the ends thereof, a connection tip intended to be mounted within a holder located anywhere, for example, on the gearbox, in the case of an application in the automotive field.

The cable or the like, in being subjected to different thrust and/or traction forces, usually coaxial, such forces are transmitted directly to the connection tip.

To try to overcome this drawback, it was proposed to ensure filtration at the attachment of the tip, within the corresponding holder thereof.

Generally, according to the prior art, dampers of a special geometry and design are used.

The results are not, however, satisfactory in the absence of a rigid stop, which generates varying travel losses as a function of the output of the filtration. Furthermore, the feedback is not the same at the beginning and end of the endurance.

The object of at least some implementations of the invention is to remedy at least some of these drawbacks in a simple, safe, efficient and rational manner.

The problem posed is to ensure filtration, with the object in at least some implementations of obtaining progressive transmission of force, until reaching a hard point at the end of travel, then, secondarily, to completely transmit the force, the purpose sought being to limit losses in travel and force.

To solve such a problem, a filter connection tip of a sheath or cable in a holder was designed and developed.

### SUMMARY

According to the disclosure, the connection tip comprises a first element made of a rigid material and attached to the end of the sheath or cable, and a second element made of a flexible material and molded over the first element, each of said elements defining two portions intended to be inserted into an arrangement of a holder having limited coaxial movement capability corresponding, under an axial force exerted on the sheath or cable, to crushing said portion of the flexible element up to a symmetrical contact area abutment position on the surface of said portion, said contact areas abutting against a portion of the arrangement of the holder to limit the travel under the force of the crushing of the flexible material of the second element.

It follows from these characteristics that a fixed force point of transmission is obtained, with constant feedback, the filtration being, moreover, performed, both coaxially and angularly.

To solve the problem posed of ensuring a connection between the two elements, i.e., of guaranteeing a unitary character at the tip, the portion of the element made of a rigid material has openings for the adhesion of the flexible material of the second element.

In one embodiment, the portion of the element made of a rigid material consists of a collar, the arrangement of the holder consisting of a groove.

The thickness of the collar, including the molded flexible material, is substantially equal to the width of the groove of the holder.

The dimensions of the width and the depth of the groove, and of the thickness of the flexible material at the collar, are defined in order to allow angular displacement of said tip.

According to another characteristic in at least some implementations, the rigid material of the first element is a plastic material and the flexible material of the second element is an elastomeric material.

As indicated, at least some embodiments of the invention find particularly advantageous application in the automotive field, particularly for the attachment, for example, of the control cable of a mechanical or automatic gearbox.

### DESCRIPTION OF THE DRAWINGS

Certain embodiments of the invention are disclosed below in more detail using the figures from the attached drawings, wherein:

FIG. 1 is a perspective view from one end of the cable or the like, provided with a connection tip,

FIG. 2 is a perspective view of the end of a cable fitted to the first element of a rigid material,

FIG. 3 is a front view, corresponding to FIG. 2,

FIG. 4 is a side view, corresponding to FIG. 3,

FIG. 5 is a sectional view, showing the installation of the connection tip within a holder,

FIG. 6 is a view corresponding to FIG. 5, showing the deformation of the elastomeric portion until contact with the rigid part on the holder, the cable being subjected to a force of traction symbolized by the arrow F, and

FIG. 7 is a view showing the different possibilities for dimensional modifications, in order to change in a corresponding manner, the axial travel and the angular displacement of the tip in relation to the holder to which it is attached.

### DETAILED DESCRIPTION

As indicated, the disclosure relates to a connection tip, designated as a whole by (E), for the attachment of a cable (C) or the like (sheathes, inserts, . . . ) within a holder (1).

For example, the holder (1) is mounted on part of a gearbox, as part of an application in the automotive field, for example, the selection and the changing of gears.

According to at least one embodiment, the connection tip (E) results from the combination of two elements (2) and (3), wherein the first (2) is made of a rigid material, whilst the second (3) is made of a flexible material. The element (2), made of a rigid material, is attached at the end of the cable (C), for example by molding. The second element (3), made of a flexible material, is molded onto the first element (2) of a rigid material.

The connection tip (E) has a general, overall cylindrical shape. Thus, the rigid element (2) has a cylindrical journal (2a) molded onto the cable (C), extended by the end collar (2b). As indicated, the element made of soft material (3) is molded onto the rigid element (2), thus defining a cylindrical journal (3a) and a collar (3b) corresponding respectively to the journal (2a) and to the collar (2b). The collar (3b) may be extended by an end journal (3c) terminated by a conical nose (3c1).

The collar (2b) has, facially, in a symmetrical manner and regularly distributed over a circumference, recesses (2c) defining contact zones (2d), capable of abutting against a portion of the holder (1), as will be described later within the description.

The collar (2b) also has openings (2e) for the adhesion of the soft material constituting the element (3).

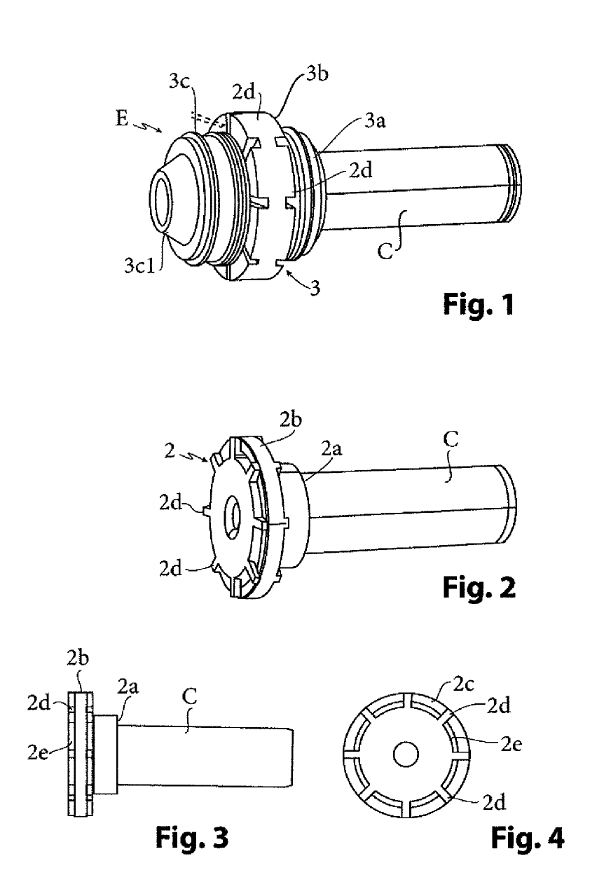

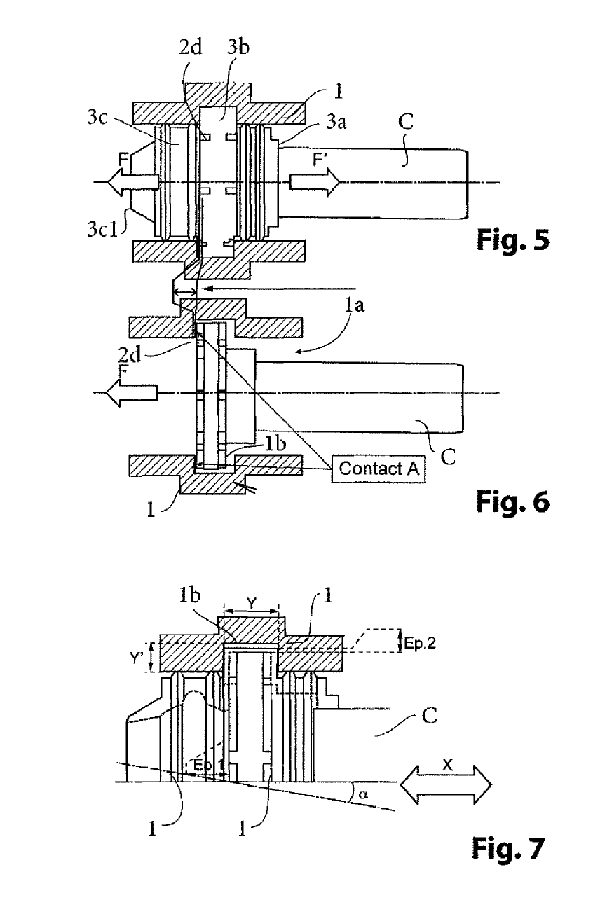

It follows from these arrangements that after the molding of the element (3), the contact zones (2d) open onto each of the faces of the collar (3b) of the element (3), while being set back from said faces (FIG. 1).

The connection tip, may be introduced into a bush (1a) of the holder (1), the collar (3b) being positioned within a groove (1b), carried by said bush (1a). The tip (1) is therefore mounted with limited coaxial movement capability corresponding, under an axial force exerted on the cable (C), to crushing said collar (3b) of the element (3) of a flexible material, up to an abutment position (2d) of the contact areas (2d) of the rigid element (2) against one of the faces of the groove (1b) of the holder (1). The thickness of the collar (3b) that forms the flexible element (3) after molding is roughly equal to the width “y” of the groove (1a).

The rigid element (2) may be made of a plastic material, while the flexible element (3) is made of an elastomeric material.

Reference will now be made to FIG. 6, which shows the filtration obtained when the cable (C) is subject to a force (F), for example.

The elastomeric material of the element (2) is compressed until the contact zones (2d) of the rigid element (2) abut against the face (1b1) of the groove (1b), thus limiting loss of travel. The possible travel of the tip within the groove is always the same, regardless of the hardness of the elastomeric material. Only the force required in order to implement this possible travel can vary, which can be set according to the hardness of the elastomeric material.

Moreover, as shown in FIG. 7, the axial travel “x” can vary by changing the thickness (ep1) of the elastomeric portion projecting from the plastic portion, and the dimension “y” corresponding to the width of the groove (1a).

It is also possible to vary the angular displacement α, by changing the thickness (ep2), the elastomeric portion and the depth “y′” of the groove (1a). It is worth noting that the variation in axial travel also has an impact on the angular displacement.

The advantages of at least some embodiments clearly emerge from the description, in particular, it should be pointed out and recalled that:
the rigid stop obtained by the compression of the elastomeric material makes it possible, firstly, to obtain a dual-slope response with progressive transmission of force, and secondly, the reaching of the hard point at the end of the travel in order to fully transmit the force.
the limitation of loss of travel and force,
a fixed point of transmission of force, throughout the lifetime of the tip,
a fixed loss of travel, allowing for precise dimensioning of the constituent elements,
constant feedback when controlling the force,
filtration performed, both axially and angularly by means of a single element.

1. A filter connection tip of a sheath or cable in a holder comprising a first element made of a rigid material and attached to the end of the sheath or cable, and a second element made of a flexible material and molded over the first element, each of said elements and defining a portion and intended to be inserted into an arrangement of the holder having limited coaxial movement capability corresponding, under an axial force exerted on the sheath or cable, to crushing said portion of the flexible element up to a symmetrical contact area abutment position on the surface of said portion, said contact areas abutting against a portion of the arrangement of the holder to limit the travel under the force of the crushing of the flexible material of the second element.

2. The connection tip according to claim 1, wherein the portion of the element made of a rigid material has openings for the adhesion of the flexible material of the second element.

3. The connection tip according to claim 1, wherein the portion of the element made of a rigid material is constituted by a collar, the arrangement of the holder consisting of a groove.

4. The connection tip according to claim 3, wherein the thickness of the collar including the molded flexible material is substantially equal to the width of the groove of the holder.

5. The connection tip according to claim 3, wherein the dimensions of the width and the depth of the groove, and of the thickness of the flexible material at the collar, are defined in order to allow angular displacement of said tip.

6. The connection tip according to claim 1, wherein the rigid material of the first element is a plastic material.

7. The connection tip according to claim 1, wherein the flexible material of the second element is an elastomeric material.

8. A use of the filter connection tip, according to claim 1, in the automotive field for the attachment of the control cable of a gearbox.
